(19) United States
(12) Patent Application Publication
(10) Pub. No.: US 2014/0342613 A1
(43) Pub. Date: Nov. 20, 2014

(54) Electrical connector

(71) Applicant: Yi-Fang Chuang, New Taipei City (TW)

(72) Inventor: Yi-Fang Chuang, New Taipei City (TW)

(21) Appl. No.: 14/120,271

(22) Filed: May 14, 2014

(30) Foreign Application Priority Data
May 14, 2013 (TW) 102208937

(51) Int. Cl. H01R 12/71

(52) U.S. Cl. CPC H01R 12/712
USPC 439/626

(57) ABSTRACT

An electrical connector includes a housing, an insulative base, a plurality of first terminals and a plurality of second terminals. The housing includes a pair of first positioning pins and a pair of second positioning pins thereon, and a connecting line among the first positioning pins and the second positioning pins circumferences into a rectangular shape. The insulative base is received inside the housing and includes a soldering surface exposed out of the housing and within the rectangular shape. The first terminals are embedded inside the insulative base and protruded out of the soldering surface to form a column of first soldering pins. The second terminals are embedded inside the insulative base and protruded out of the soldering surface to form a column of second soldering pins. The first and second soldering pins are arranged parallel to each other in columns with a column distance between 1.3 mm to 1.5 mm.

### BACKGROUND OF THE INVENTION

1. Field of the Invention

The present invention is related to a connector, in particular, to a one-piece electrical connector capable of accommodating stackable connector pin slots.

2. Description of Related Art

Connectors are widely adapted in various electronic devices for data and information transmissions. As the demand for data and information transmission among electronic devices increases, a typical electronic device is required to be equipped with more and more connectors. Nevertheless, different electronic devices are equipped with different connectors, and the specifications of the connectors various from one another while their soldering pins are too incompatible to each other. Therefore, the mainboard of each type of electronic devices need to be configured with different types of pins in correspondence with the connectors to be attached thereon. Furthermore, in order to configure more connectors in a limited space inside the electronic device, the design of a stackable connector formed by stacking a multiple number of connectors together is evolved; wherein only the bottom most connector in such stack is soldered onto the mainboard while the rest of the connectors need to be provided with extended soldering pins configured to cross over the connector at the bottom in order to be soldered onto the mainboard. However, the configurations of the pin slots of the extension soldering pins are often different from the ones of the conventional version of one-piece connector; consequently, they are not compatible with or cannot share the machine pin slots of the one-piece connector.

In view of the above, to achieve the aforementioned objective, the inventor seeks to overcome the shortcomings by providing the present invention with a reasonable design and effectiveness after years of researches and application of academic principles and theories.

### SUMMARY OF THE INVENTION

An objective of the present invention is to provide a one-piece electrical connector capable of accommodating stackable connector pin slots.

To achieve the aforementioned objective, the present invention provides an electrical connector comprising a housing, an insulative base, a plurality of first terminals and a plurality of second terminals. The housing includes a pair of first positioning pins and a pair of second positioning pins formed to extend thereon, and a connecting line among the first positioning pins and the second positioning pins circumferences into a rectangular shape. The insulative base is received inside the housing and includes a soldering surface exposed out of the housing and located within the rectangular shape. The first terminals are embedded inside the insulative base and extended to protrude out of the soldering surface in order to form a column of first soldering pins. The second terminals are embedded inside the insulative base and extended to protrude out of the soldering surface in order to form a column of second soldering pins. The second soldering pins and the first soldering pins are arranged parallel to each other in columns and a column distance between the columns is between 1.3 mm to 1.5 mm.

Preferably, in the aforementioned electrical connector, wherein the soldering surface includes a positioning column protruded therefrom; the positioning column is between the two first positioning pins.

Preferably, in the aforementioned electrical connector, wherein a central distance between the first positioning pin and the second positioning pin most adjacent thereto is between 11.5 mm to 12 mm.

Preferably, in the aforementioned electrical connector, wherein a central distance between the two first positioning pins is between 16 mm to 17 mm.

Preferably, in the aforementioned electrical connector, wherein a central distance between the two second positioning pins is between 16 mm to 17 mm.

Preferably, in the aforementioned electrical connector, wherein a central distance between he two first soldering pins adjacent to each other is between 1.2 mm to 1.5 mm.

Preferably, in the aforementioned electrical connector, wherein a central distance between the two second soldering pins adjacent to each other is between 1.2 mm to 1.5 mm.

Preferably, in the aforementioned electrical connector, wherein the plurality of first soldering pins and the plurality of second soldering pins are arranged in an alternate and non-overlapping manner.

In comparison to the prior art, the electrical connector of the present invention is able to utilize the extended central distance between the first positioning pins and the second positioning pins as well as the increased column distance between columns of the first soldering pins and the second soldering pins in order to accommodate pin slots of a stackable connector.

### BRIEF DESCRIPTION OF DRAWING

FIG. 1 is a perspective view of a preferred embodiment of the present invention;

FIG. 2 is another perspective view of a preferred embodiment of the present invention;

FIG. 3 is a bottom view of a preferred embodiment the present invention;

FIG. 4 is a front view of a preferred embodiment of the present invention;

FIG. 5 is a rear view of a preferred embodiment of the present invention; and

FIG. 6 is side view of a preferred embodiment of the present invention.

### DETAILED DESCRIPTION OF THE INVENTION

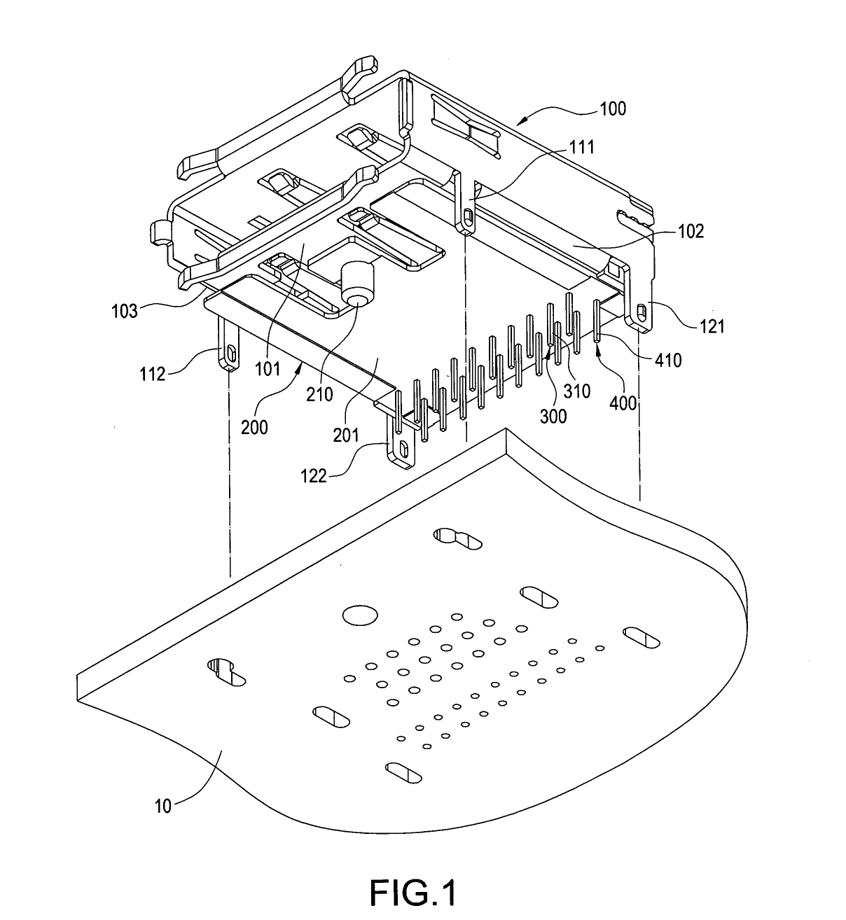

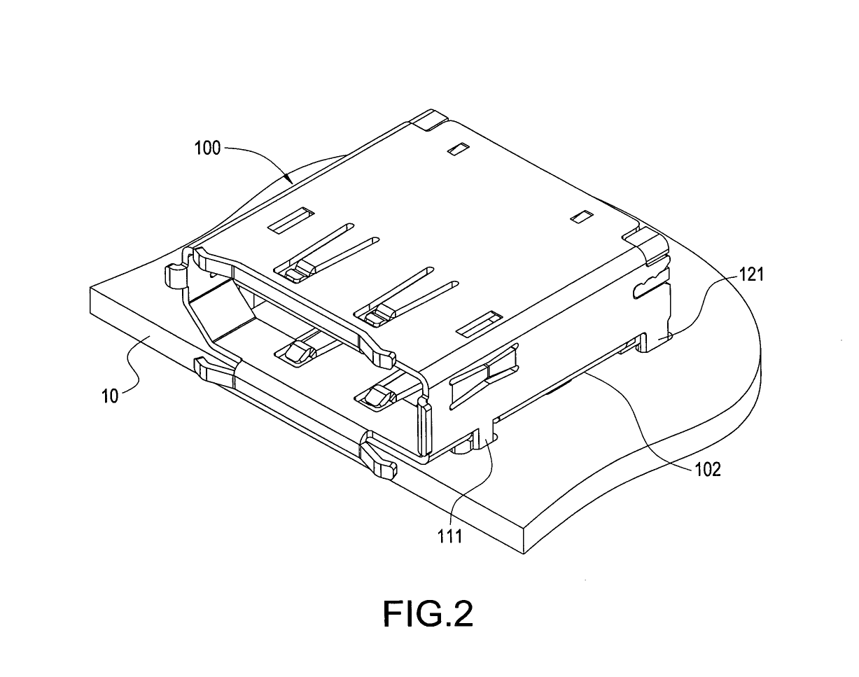

Please refer to FIG. 1 and FIG. 2. According to a preferred embodiment of the present invention, an electrical connector configured to be disposed on a circuit board 10 is provided; the electrical connector comprises a housing 100, an insulative base 200, a plurality of first terminals 300 and a plurality of second terminals 400.

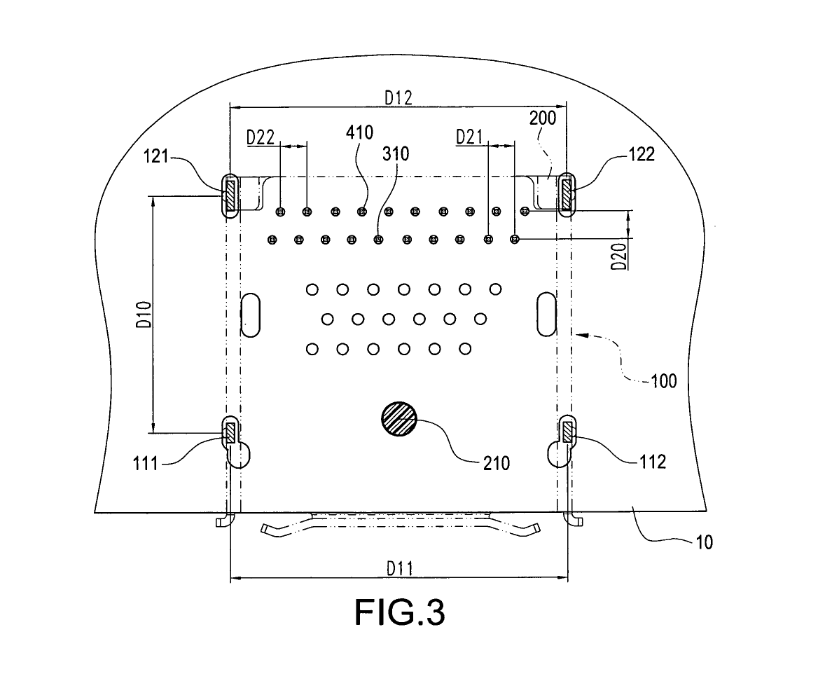

Please refer to FIG. 1 and FIG. 3. The housing 100 is preferably formed by bending a metal sheet into a rectangular tubular body. One lateral surface 101 of the housing 100 includes a pair of first positioning pins 111/112 and a pair of second positioning pins 121/122 formed to extend thereon. The pair of first positioning pins 111/112 and the pair of second positioning pins 121/122 are preferably located on a pair of lateral sides 102/103 opposite from the lateral surface 101 respectively; one of the first positioning pins 111 and one of the second positioning pins 121 are located on one identical lateral side 102; whereas the other of the first positioning pins 112 and the other of the second positioning pins 122 are located on another lateral side 103. Therefore, a connecting line among the pair of the first positioning pins 111/112 and the pair of the second positioning pins 121/122 circumferences into a rectangular shape. In this embodiment, the rectangular shape is preferably a rectangle; however, the present invention is not limited to such shape only.

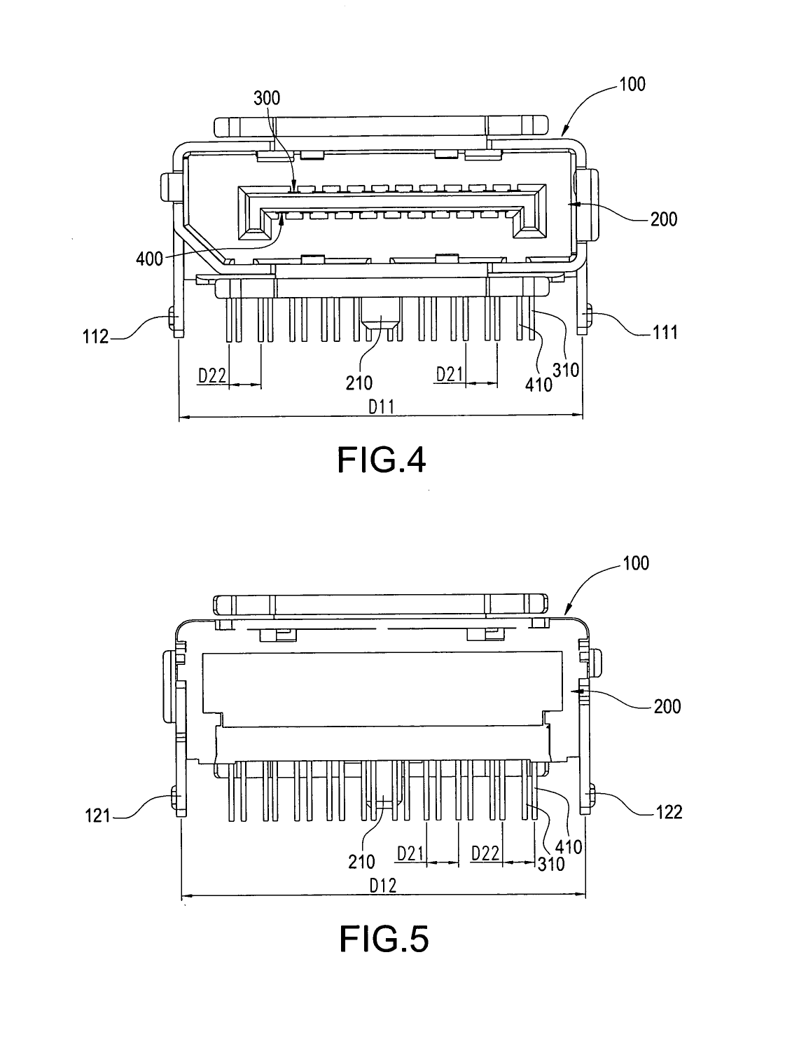

Please refer to FIG. 4 to FIG. 6. A central distance D10 between the first positioning pin 111 (112) and the second positioning pin 121 (122) on one identical lateral side 102 (103) is preferably between 11.5 mm to 12 mm; and in this embodiment, it is most preferred to be 11.9 mm. A central distance D11 between the two first positioning pins 111/112 is preferably between 16 mm to 17 mm; and in this embodiment, it is most preferred to be 16.5 mm. A central distance D12 between the two second positioning pins 111/112 is preferably between 16 mm to 17 mm; and in this embodiment, it is most preferred to be 16.5 mm.

Please refer to FIG. 1 and FIG. 3. The insulative base 200 is preferably formed by injection modeling and is received to secure inside the housing 100. The insulative base 200 includes a soldering surface 201. The soldering surface 201 is exposed out of the housing 100, and the soldering surface 201 is disposed within the rectangular shape circumferenced by the first positioning pins 111/112 and the second positioning pins 121/122. The soldering surface further includes a positioning column 210 protruded therefrom, and the positioning column 210 is preferably between the two first positioning pins 111/112.

Please refer to FIG. 1 and FIG. 3 to FIG. 5. In this embodiment, the electrical connector of the present invention preferably comprises 10 first terminals 300, and the first terminals 300 are embedded inside the insulative base 200. Each one of the first terminals extends to protrude out of the soldering surface 201 in order to form a first soldering pin 310, and the plurality of first soldering pins 310 are arranged in a column parallel and spaced apart from each other on the soldering surface 201. A central distance D21 between the two first soldering pins 310 adjacent to each other is between 1.2 mm and 1.5 mm; and in this embodiment, the central distance D21 of a portion of the first soldering pins is 1.4 mm while the central distance D21 of the rest of the first soldering pins is 1.3 mm.

In this embodiment, the electrical connector of the present invention preferably comprises 10 second terminals 400, and the second terminals 400 are embedded inside the insulative base 200. Each one of the second terminals extends to protrude out of the soldering surface 201 in order to form a second soldering pin 410, and the plurality of second soldering pins 410 are arranged in a column parallel and spaced apart from each other on the soldering surface 201; in addition, the plurality of second soldering pins 410 are arranged between the two second positioning pins 121/122. A central distance D22 between the two second soldering pins 410 adjacent to each other is between 1.2 mm and 1.5 mm; and in this embodiment, the central distance D22 of a portion of the second soldering pins is 1.4 mm while the central distance D22 of the rest of the second soldering pins is 1.3 mm.

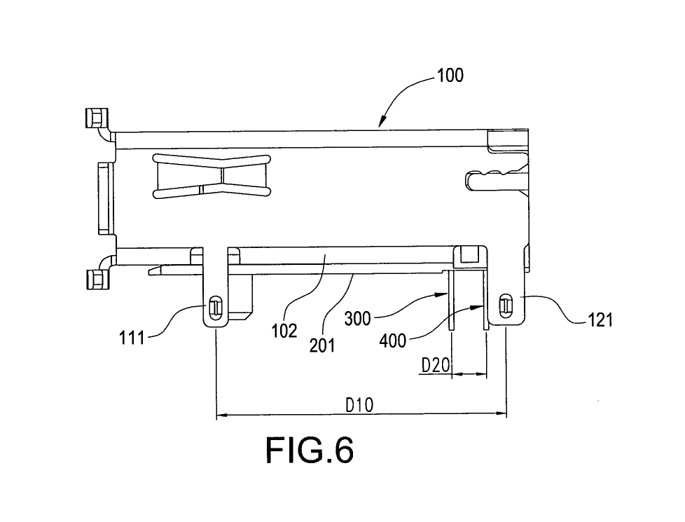

As shown in FIG. 1, FIG. 3 and FIG. 6, the aforementioned first soldering pins 300 and the second soldering pins 400 are arranged into two columns parallel to each other, and the first soldering pins are closer to the first positioning pins 111/112 than the second soldering pins 400. The plurality of first soldering pins 300 and the plurality of second soldering pins 400 are arranged in an alternate and non-overlapping manner. A column distance D20 between the column of the first soldering pin 300 and the column of the second soldering pin 400 is between 1.3 mm to 1.5 mm.

In comparison to the prior art, the electrical connector of the present invention is able to utilize the extended central distance between the first positioning pins 111 (112) and the second positioning pins 121 (122) as well as the increased column distance between the columns of the first soldering pins 310 and the second soldering pins 410 in order to accommodate pin slots of a stackable connector on a common circuit board 10.

The above descriptions on the embodiments of the present invention are provided for illustrative purposes only, which shall not be treated as limitations of the present invention. Any other equivalent modifications within the spirit of the present invention shall be deemed to be within the scope of the present invention.

What is claimed is:

1. An electrical connector, comprising:
a housing having a pair of first positioning pins and a pair of second positioning pins formed to extend thereon; a connecting line among the pair of first positioning pins and the second positioning pins circumferencing into a rectangular shape;
an insulative base received inside the housing; the insulative base having a soldering surface; the soldering surface exposed out of the housing and located within the rectangular shape;
a plurality of first terminals embedded inside the insulative base, and each one of the first terminals extended to protrude out of the soldering surface in order to form a first soldering pin;
the plurality of first soldering pins arranged in a column parallel and spaced apart from each other; and
a plurality of second terminals embedded inside the insulative base, and each one of the second terminals extended to protrude out of the soldering surface in order to form a second soldering pin; the plurality of second soldering pins arranged in a column parallel and spaced apart from each other as well as between the two second positioning pins; the column of the second soldering pins arranged parallel to the column of the first soldering pins and the column of the first soldering pins arranged relatively closer to the first positioning pins; a column distance between the column of the first soldering pin and the column of the second soldering pin is between 1.3 mm to 1.5 mm.

2. The electrical connector according to claim 1, wherein the soldering surface includes a positioning column protruded therefrom; the positioning column is between the two first positioning pins.

3. The electrical connector according to claim 1, wherein a central distance between the first positioning pin and the second positioning pin most adjacent thereto is between 11.5 mm to 12 mm.

4. The electrical connector according to claim 1, wherein a central distance between the two first positioning pins is between 16 mm to 17 mm.

5. The electrical connector according to claim 1, wherein a central distance between the two second positioning pins is between 16 mm to 17 mm.

6. The electrical connector according to claim 1, wherein a central distance between the two first soldering pins adjacent to each other is between 1.2 mm to 1.5 mm.

7. The electrical connector according to claim 1, wherein a central distance between the two second soldering pins adjacent to each other is between 1.2 mm to 1.5 mm.

8. The electrical connector according to claim 1, wherein the plurality of first soldering pins and the plurality of second soldering pins are arranged in an alternate and non-overlapping manner.
